(19) United States
(12) Patent Application Publication
(10) Pub. No.: US 2026/0340548 A1
(43) Pub. Date: Oct. 29, 2026

(54) SYSTEMS AND METHODS FOR ASSESSING VULNERABILITY MITIGATION EFFECTIVENESS

(71) Applicant: The PNC Financial Services Group, Inc., Pittsburgh, PA (US)

(72) Inventor: Jessica DeWilde, Las Vegas, NV (US)

(21) Appl. No.: 19/390,819

(22) Filed: Nov. 17, 2025

Related U.S. Application Data
(60) Provisional application No. 63/796,683, filed on Apr. 29, 2025.

(51) Int. Cl. G06Q 10/0635; H04L 9/40

(52) U.S. Cl. CPC G06Q 10/0635; H04L 63/1433

(57) ABSTRACT

Computer implemented methods and systems for monitoring controls and assessing their effectiveness by implementing an observation tool. Some embodiments involve generating a first interactive graphical user interface and receiving a first input of an operational unit corresponding to a vulnerability. Some embodiments involve receiving a second input of a control identifier to identify a control corresponding to the operational unit and a third input of a performance field including at least one data element based on the generated test result data. Some embodiments involve generating test result data indicative of a performance of the control and analyzing effectiveness of the control. Some embodiments involve compiling a summary report including the first input, the second input, the third input, the fourth input, and input data associated with a plurality of control identifiers and generating a second interactive graphical user interface configured to display performance status information associated with the summary report.

### CROSS REFERENCE TO RELATED APPLICATIONS

This application claims the benefit of priority of U.S. Provisional Patent Application No. 63/796,683 filed on Apr. 29, 2025, the contents of which are incorporated herein by reference in their entirety.

### BACKGROUND

When assessing controls across an organization’s departments, sectors, or groups, stakeholders often are unable to accurately identify or assess all controls across the organization. This lack of oversight may result in ineffective, redundant, or inadequate controls and their evaluation methods. Controls may include systems or methods tailored to mitigate vulnerability. A control may refer to a policy, procedure, process, or other technical safeguard that mitigates a threat to an organization. Examples of vulnerabilities may include incorrect or incomplete data, as well as data processing mistakes that may lead to non-compliance with regulations. A control meant to mitigate a vulnerability related to data processing mistakes may include an analyst routinely spot-checking data for compliance or using a computer program to flag incompliant data. Another example of a vulnerability may be a bad actor stealing confidential data from an organization. The relevant control may include blocking unapproved portable memory devices, such as a USB stick. Organizations, particularly large organizations with various functions (e.g., operations, human resources, finance, engineering, legal), are at risk of vulnerabilities ranging from global pandemics to data breaches. The ability to identify the controls in place, how they work, which vulnerabilities they are addressing, and how effective they are is a challenge many organizations face. However, effectively and efficiently identifying controls may improve organizational efficiencies by removing redundant controls or identifying inadequate controls. These capabilities may improve an organization’s security through access controls, which may limit and manage access and privileges to information; providing asset management across an organization to, for example, push secure updates across a platform; provide security controls such as firewalls to protect against malicious actors; and monitoring and auditing controls, which may be used to identify the effectiveness of controls.

The present disclosure relates to systems and methods for monitoring controls and assessing their effectiveness by implementing a monitoring tool. For example, a graphical user interface or monitoring tool that permits observers (e.g., agents, people, or systems) monitoring controls, to effectively audit their department’s controls in compliance with a standard set forth by a larger organization. The monitoring tool may identify periodic enhancement opportunities for controls, which may include identifying opportunities to improve a given control’s prevention or mitigation of an associated risk. The monitoring tool may enhance an entity’s ability to identify risks, weaknesses of controls, and gaps in addressing risks. The monitoring tool may improve risk management and may reduce impacts on customer experience. For example, risks to an application may include down time due to traffic or bug fixes. The monitoring tool may be used to improve mitigation efforts directed to addressing these risks by anticipating traffic or enhancing testing to prevent proliferation of bugs.

### SUMMARY

The disclosed embodiments describe computer readable mediums, systems, and methods for monitoring controls and assessing their effectiveness by implementing an observation tool. For example, the systems and methods may include generating a first interactive graphical user interface. The systems and methods may further include receiving, by the first interactive graphical user interface, a first input of an operational unit corresponding to a vulnerability and receiving, by the first interactive graphical user interface, a second input of a control identifier to identify a control corresponding to the operational unit and configured to remediate the vulnerability. The systems and methods may further include generating test result data indicative of a performance of the control in minimizing the vulnerability, comparing the test result data against attributes of the operational unit to identify one or more control gaps, and receiving, by the first interactive graphical user interface, a third input of a performance field including at least one data element based on the generated test result data. The systems and methods may further include analyzing, based on the identified one or more control gaps, an effectiveness of the control relative to the operational unit, receiving, by the first interactive graphical user interface, a fourth input of an exception and enhancement field corresponding to the analysis of the effectiveness of the control, and storing, in at least one database, the first input, the second input, the third input, and the fourth input. The systems and methods may further include compiling a summary report including the first input, the second input, the third input, the fourth input, and input data associated with a plurality of control identifiers, and generating a second interactive graphical user interface configured to display performance status information associated with the summary report.

Throughout this disclosure, the phrase “disclosed embodiments,” refers to examples of inventive ideas, concepts, and/or manifestations described herein. Many related and unrelated embodiments are described throughout this disclosure. The fact that some “disclosed embodiments” are described as exhibiting a feature or characteristic does not mean that other disclosed embodiments necessarily share that feature or characteristic. Likewise, the fact that some “disclosed embodiments” are described as exhibiting a feature or characteristic does not mean that other disclosed embodiments cannot share that feature or characteristic.

It is to be understood that both the foregoing general description and the following detailed description are exemplary and explanatory only, and are not restrictive of the disclosed embodiments, as claimed.

### BRIEF DESCRIPTION OF THE DRAWINGS

FIG. 1 illustrates a risk manager considering monitoring and tracking controls that mitigate or eliminate vulnerabilities to the organization.

FIG. 2 illustrates an organization monitoring controls and assessing their effectiveness by implementing an observation tool, consistent with disclosed embodiments.

FIG. 3 is a diagram of an exemplary system for organizations and risk managers interacting with a control observation monitoring tool, consistent with disclosed embodiments.

FIG. 4 is a block diagram showing an example computing device, consistent with disclosed embodiments.

FIG. 5 illustrates a graphical user interface configured to receive inputs related to controls and their effectiveness at mitigating vulnerabilities, consistent with disclosed embodiments.

FIG. 6 is a flowchart illustrating an example process for receiving inputs related to a control through a graphical user interface, consistent with disclosed embodiments.

FIG. 7 is a diagram of an exemplary system architecture for receiving inputs related to a control through a graphical user interface, consistent with disclosed embodiments.

FIG. 8 illustrates reports and graphs output from the control observation tool, consistent with disclosed embodiments.

### DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof may occur or be performed simultaneously, at the same point in time, or concurrently.

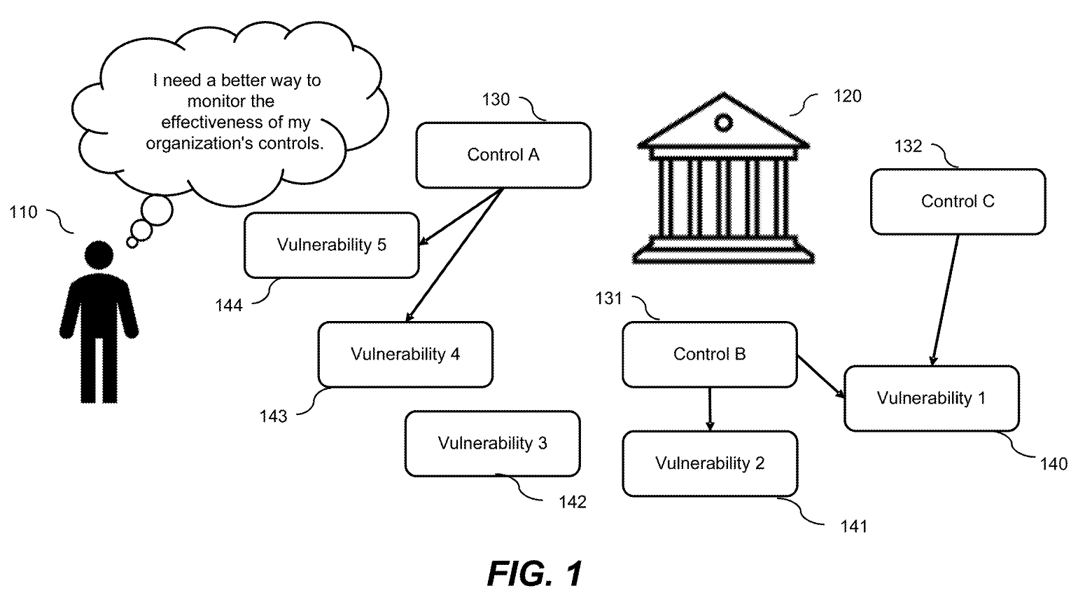

FIG. 1 illustrates an exemplary application for monitoring and tracking controls that mitigate or eliminate vulnerabilities to the organization, consistent with disclosed embodiments. This exemplary application represents how an organization 120, which may be an individual, a financial institution, or other organization, may be exposed to various vulnerabilities and implement various controls without the proper oversight to understand the controls in place, how they work, which vulnerabilities they are addressing, and how effective they are. For example, organization 120 is exposed to vulnerabilities #1-5 (140-144) and controls A-C (130-132), however, there is no control in place to address vulnerability #3 142 and there are redundant controls for vulnerability #1 140. For example, vulnerability #1 (140 could be incomplete data entry in a financial system, which is addressed by both Control A (130) (e.g., a manual spot-check by an analyst in finance) and Control B (131) (e.g., a spot check by an associate in regulatory compliance), resulting in a duplication of effort that may not be necessary. Vulnerability #2 (141) might be unauthorized access to confidential files that is mitigated by Control C (132) that restricts access permissions. Vulnerability #3 (142), such as phishing attacks remains unaddressed in FIG. 1, highlighting a gap in the organization’s 120 control framework. Entity 110, which may be an individual, such as an individual who works for an entity, such as organization 120, recognizes the importance of systematically monitoring controls implemented by organization 120. The systems and methods disclosed herein utilize a monitoring tool to monitor controls and assess their effectiveness, while allowing organization 120 and entity 110 to act on the best information available. While FIG. 1 only illustrates an entity 110 and one organization 120, the disclosed systems and methods may be applicable to any number of entities 110, organizations 120, or any other persons or entities consistent with the present disclosure.

As illustrated in FIG. 1, there is a need for organizations 120 to gain and maintain visibility of its control framework. Without systematic observation and monitoring, organizations may be operating in an environment where controls exist, but their coverage and effectiveness are unclear. In addition, controls may be static, rather than dynamic, and thus are unable to respond to issues as they occur in real-time. A monitoring approach, as further described herein, may enable stakeholders to understand which vulnerabilities are addressed, identify gaps where no controls exist, and detect redundancies that waste resources.

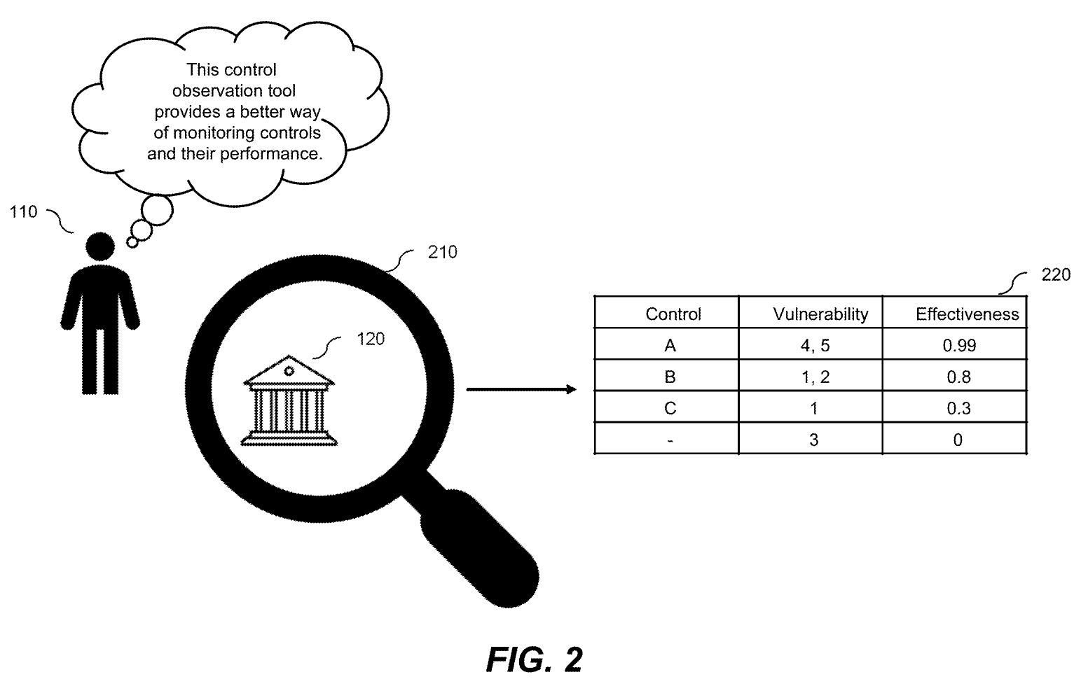

FIG. 2 illustrates an organization monitoring controls and assessing their effectiveness by implementing a monitoring tool 210, consistent with disclosed embodiments. For example, the organization leverages a graphical user interface to systematically collect inputs regarding operational units within organization 120 (e.g., operations, human resources, finance, engineering, legal), identified vulnerabilities, and the controls intended to mitigate or eliminate those vulnerabilities. Monitoring tool 210 enables users, such as risk managers or other agents of the organization, to input data about the control, its performance, and opportunities for enhancement. For example, the monitoring tool may prompt users to record the results of their observation of the control and suggest automation where appropriate. By aggregating and analyzing this data, the monitoring tool may generate actionable insights such as identifying control gaps (e.g., missing data security measures), removing unnecessary redundant controls (e.g., two manual spot-checks by agents of different departments), recommending improvements to the existing control framework, and producing graphs and figures to communicate the control framework to stakeholders such as entity 110.

For example, the monitoring tool may identify control gaps by collecting feedback from observers. Observers may input data directly regarding a control gap, or the tool may detect gaps by analyzing qualitative data. For instance, an observer might report the number of security incidents, or the tool could integrate with an enterprise system that already stores this information. By comparing incident counts before and after a control is implemented, the tool may identify control gaps.

Next, because the monitoring tool gathers feedback from multiple organizational units (e.g., operations, human resources, finance, engineering, legal), it can identify overlapping controls. For example, the information technology department may perform checks to ensure software is secure against cyberattacks, while engineering conducts the same checks independently. Both departments may be unaware of this duplication. With the monitoring tool’s oversight, stakeholders may recognize redundant efforts and determine that a second check offers little additional vulnerability mitigation and may provide redundancy that leads to inefficiencies. Consequently, they may instruct engineering to discontinue its checks since the information technology department already performs them.

Further, the monitoring tool can provide insights into improving the control framework. Because it aggregates data across departments, the tool can assess the relative effectiveness of specific controls. For example, research and development may enforce stricter access controls to reduce the risk of confidential data leaks, resulting in fewer cybersecurity incidents. Leveraging this cross-departmental data, the monitoring tool can deliver concrete recommendations to strengthen the overall control framework.

After collecting the control data framework, the monitoring tool may store and organize the data in a format such as table 220. Table 220 uses the data collected from monitoring tool 210 and associates the data with the relevant control. The monitoring tool 210 may be implemented through a graphical user interface. The interface may collect data from inputs, automated feeds, or enterprise systems using configurable dashboards, forms, or other data pipelines. The monitoring tool 210 may provide dynamic visualization of control performance through graphs and charts. By centralizing feedback and analytics in one platform, monitoring tool 210 may remove silos and speed decision-making. Table 220 may be an example of an output of the monitoring tool. For example, table 220 shows Control A addressing vulnerabilities #4 and #5 with 99% effectiveness and associates the data with the relevant control and vulnerability.

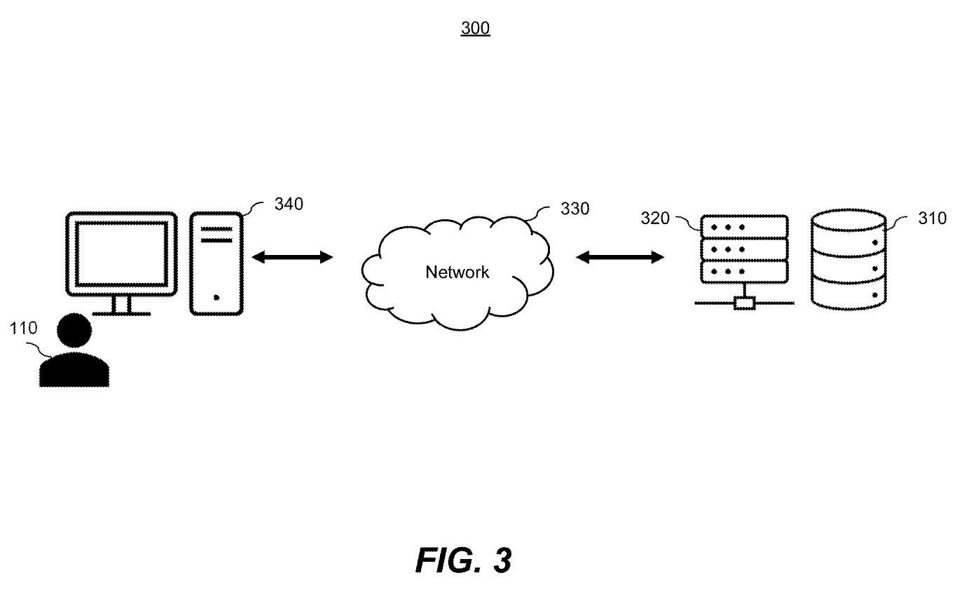

FIG. 3 illustrates a diagram of an exemplary system for organizations and risk managers interacting with a control observation monitoring tool, consistent with disclosed embodiments. System environment 300 may include one or more organizational endpoint devices 340, one or more computing devices 320, and one or more databases 310.

The various components of system 300 may communicate over a network 330. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. While system environment 300 is shown as a network-based environment, it is understood that in some embodiments, one or more aspects of the disclosed systems and methods may also be used in a localized system, with one or more of the components communicating directly with each other.

Computing device 320 may include any form of remote computing device configured to receive, store, and transmit data. For example, computing device 320 may be a server configured to store files accessible through a network (e.g., a web server, application server, virtualized server, etc.). Computing device 320 may interact with a database 310, for example, a loan information database, to receive and/or store information. Database 310 may be included on a volatile or non-volatile, magnetic, semiconductor, tape, optical, removable, non-removable, or other type of storage device or tangible or non-transitory computer-readable medium. Database 310 may also be part of computing device 320 or separate from computing device 320. When database 310 is not part of computing device 320, computing device 320 may exchange data with database 310 via a communication link. Database 310 may include one or more memory devices that store data and instructions used to perform one or more features of the disclosed embodiments. Database 310 may include any suitable databases, ranging from small databases hosted on a workstation to large databases distributed among data centers. Database 310 may also include any combination of one or more databases controlled by memory controller devices (e.g., server(s), etc.) or software. For example, database 310 may include document management systems, Microsoft SQL™ databases, SharePoint™ databases, Oracle™ databases, Sybase™ databases, other relational databases, or non-relational databases, such as mongo and others. Although one database 310 is shown in FIG. 3, system environment 300 may include one or more databases 310, which may be used to store various types of information. System environment 300 may include one or more organizational endpoint devices 340 (e.g., computer workstation) that permit a user to interact with the system such as a graphical user interface or control data.

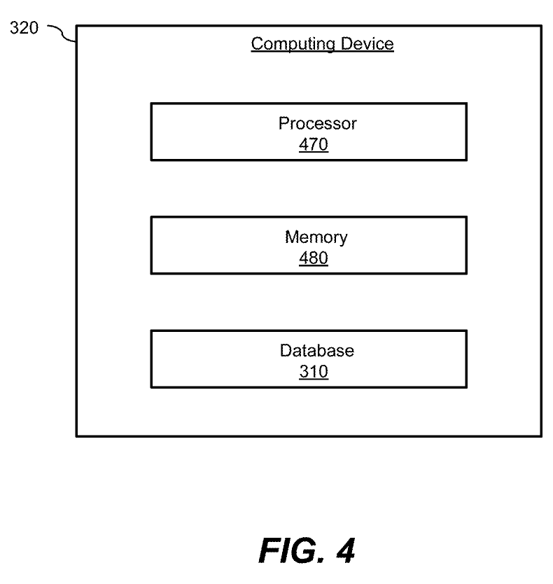

FIG. 4 illustrates a block diagram showing an example computing device, consistent with disclosed embodiments. As described above, computing device 320 may be one or more devices configured to allow data to be received and/or transmitted by system 300 (e.g., a server, etc.) and may include one or more dedicated processors and/or memories. For example, computing device 320 may include a processor (or multiple processors) 470, and a memory (or multiple memories) 480. Computing device 320 may include one or more digital and/or analog devices that may allow computing device 320 to communicate with other machines and devices, such as other components of system 300. Computing device 320 may include one or more input/output devices. Computing device 320 may include a screen for displaying communications to a user. In some embodiments computing device 320 may include a touch screen. Computing device 320 may include other components known in the art for interacting with a user. Computing device 320 may also include one or more digital and/or analog devices that may allow a user to interact with system 300, such as touch-sensitive area, keyboard, buttons, or microphones.

Processor 470 may take the form of, but is not limited to, one or more integrated circuits (IC), including application-specific integrated circuit (ASIC), microchips, microcontrollers, microprocessors, embedded processor, all or part of a central processing unit (CPU), graphics processing unit (GPU), digital signal processor (DSP), field-programmable gate array (FPGA), server, virtual server, system on an chip (SOC) or other circuits suitable for executing instructions or performing logic operations. Furthermore, according to some embodiments, processor 470 may be from the family of processors manufactured by Intel®, AMD®, Qualcomm®, Apple®, NVIDIA®, or the like. Processor 470 may also be based on the ARM architecture, a mobile processor, or a graphics processing unit, etc. The disclosed embodiments are not limited to any type of processor configured in computing device 320. In some embodiments, processor 470 may be a special purpose processor configured to perform one or more of the operations described below.

Memory 480 may include one or more storage devices configured to store instructions used by processor 470 to perform functions related to computing device 320. The disclosed embodiments are not limited to particular software programs or devices configured to perform dedicated tasks. For example, memory 480 may store a single program, such as a user-level application, that performs the functions associated with the disclosed embodiments, or may include multiple software programs. Additionally, processor 470 may, in some embodiments, execute one or more programs (or portions thereof) remotely located from computing device 320. Furthermore, memory 480 may include one or more storage devices configured to store data for use by the programs. Memory 480 may include, but is not limited to a hard drive, a solid state drive, a CD-ROM drive, a peripheral storage device (e.g., an external hard drive, a USB drive, etc.), a network drive, a cloud storage device, or any other storage device.

Computing device 320 may include a database 310, as described with respect to FIG. 3. Database 310 may also be part of computing device 320 or separate from computing device 320. In some embodiments, computing device 320 may include one or more input/output devices, communications devices, displays, and/or other interfaces (e.g., server-to-server, database to-to-database, or other network connections). One or more of an organizations endpoint devices 340 may include components similar to those discussed with respect to computing device 320 and may perform functions similar to or different from those described above with respect to computing device 320.

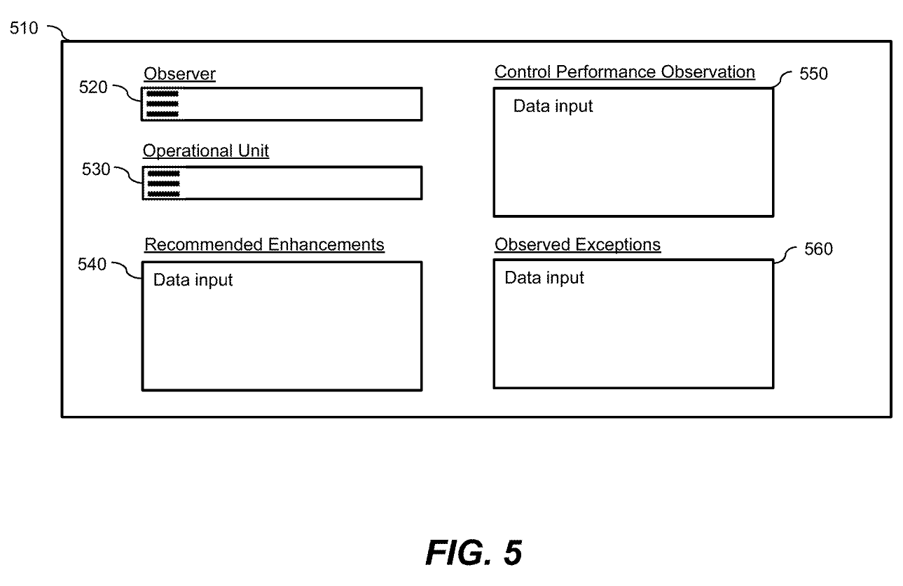

FIG. 5 illustrates a graphical user interface configured to receive inputs related to controls and their effectiveness at mitigating vulnerabilities, consistent with disclosed embodiments. The graphical user interface 510 comprises several key elements. For example, the observer field 520 allows the user to input the identity of the individual or system conducting the observation of the control’s performance. Collecting data, such as the observer’s identity, ensures traceability of the assessment process. This traceability may allow organizations to verify who conducted each assessment, maintain accountability, and audit the evaluation process of each observer to ensure each observer is accurately collecting control data. Similarly, the graphical user interface may permit the user to input their operational unit 530 such as an organizational department like operations, human resources, finance, engineering, or legal. According to some embodiments, the system may determine the operational unit (e.g., operations, human resources, finance, engineering, or legal) by correlating integrated data. For example, if the vulnerability relates to financial regulations compliance, associated metadata may automatically provide the system with the operational unit.

The graphical user interface 510 may further include a control performance observation section 550. According to some embodiments, the data to complete the control performance observation section 550 may be input by a user or auto populated through data pipelines by connecting the monitoring tool to enterprise systems that house the relevant data. For example, if the monitoring tool is integrated with the company’s incident management system, the control performance observation section 550 may automatically populate with data on recent security incidents, such as the number and severity of events detected by a firewall. This may streamline the assessment process. This collection of observation data may permit the assessment of control design and/or effectiveness. For example, the collection may allow the system to evaluate whether the control is functioning as intended and whether it is mitigating a vulnerability. For example, if a firewall is designed to block unauthorized access and the incident data shows a reduction in such events after implementation, this supports the conclusion that both controls are functioning as intended and are mitigating vulnerability. Conversely, persistent security incidents may indicate a design flaw or operational gap, prompting further review or remediation.

According to some embodiments, the control performance observation section may involve completion of one or more performance fields, which may include a frequency acknowledgement field, a frequency appropriateness field, a documented process field, a risk mitigation confirmation field, an evidence retention confirmation field, a consistency field, and an adequacy confirmation field. For example, the frequency acknowledgement field may confirm whether the control is performed at the required intervals, while the frequency appropriateness field may assess if the frequency matches the risk level and operational needs. The documented process field may verify that a written procedure exists for executing the control. The risk mitigation confirmation field may indicate whether the control is effectively reducing the targeted risk, and the evidence retention confirmation field may ensure that records of control execution are maintained for review. The consistency field may assess whether the control is applied uniformly across relevant processes or departments, and the adequacy confirmation field may evaluate if the control is sufficient in scope and design to address the identified risk. Each performance field may be associated with an additional details field, which may be configured to receive additional details about the performance field. The system may configure each performance field for a discrete input (e.g., “yes” or “no”), and receiving a “no” in a performance field may suggest a control’s inadequate performance. When receiving a “no” the system may recommend changes to the inadequate control by implementing techniques using artificial intelligence, statistical modeling, and benchmarking against data from similar controls to recommend changes or alternative controls that better mitigate the vulnerability. This structured approach to receiving data regarding the control framework of an organization may assist in identifying control gaps and informing decisions for targeted control enhancements.

Exemplary performance field questions include “was the control executed at the time the documented control frequency indicates?”; “is the control frequency appropriate?”; “did the performer follow the documented process?”; “did the performance of this control mitigate the associated risk/s as you described above in the review outline?”; “was the evidence retained as the control language states?”; “can this control be easily repeatable with consistent results?”; and “are the systems or applications needed to perform this control adequate to mitigate the risk?” A skilled artisan will understand that the phrasing of each question may be modified to seek information specific to a given control, while keeping with the purpose of seeking performance information about the control.

The graphical user interface 510 may further include an observed exceptions 560 and recommended enhancements 540 sections. The observed exceptions 560 and recommended enhancements 540 sections may involve completion of one or more exception fields, which may involve identification of one or more exceptions. An exception, in the context of control performance, may refer to any instance where a control does not operate as intended or fails to meet established performance standards. The exception fields in the graphical user interface are designed to capture these occurrences. An exception field may be configured for either receiving discrete data (e.g., “yes” or “no”) or through an established data pipeline (e.g., transfers of information from other systems). For example, the graphical user interface 510 may receive data as an answer to a yes-or-no question, such as “based on your observation noted above, did you identify any exceptions with the performance of the control?” The phrasing of the question may be modified to seek additional or similar exception information, while keeping with the purpose of seeking exception information about the control. The exception fields may further include a next steps/action plan field, which may be configured as a free-form field. Alternatively, exceptions may come in the form of established data pipelines. For example, the system may be integrated with an enterprise system tracking inventory. If an inventory tracking system deviates from standard control procedures, such as failing to reconcile inventory counts at the required frequency or missing documentation for stock movements, the system may automatically flag these deviations as exceptions.

Similarly, for example, the system may automatically monitor incoming supplies and quality sampling data to recommend enhancements to an inspection process. For example, if the system detects a rising trend in defects during sampling, it may suggest increasing the frequency of quality checks or tightening acceptance criteria. Some recommendations, such as adjusting sampling rates or automating documentation of inspection results, may be implemented immediately if predefined thresholds are met (e.g., 5 defects per 100 parts), while others, like changing suppliers, may require stakeholder approval. As new quality data is received, the system may continuously update its recommendations to ensure the inspection process remains responds to changing vulnerabilities.

After an enhancement is implemented in the incoming supplies quality control process, such as increasing the frequency of sampling inspections, the system may analyze post-implementation data to assess the impact of the enhancement. For example, it may track defect rates, inspection outcomes, and supplier compliance metrics over time, then generate feedback reports indicating whether the enhancement led to measurable improvements, such as a reduction in defective items or faster detection of quality issues. This automated feedback is based on real-time data and predefined success criteria, ensuring objective and consistent evaluation. In addition to machine-generated insights, a quality engineer can supplement the assessment by providing their own observations, commentary, or supporting documentation through dedicated input fields of the graphical user interface 510.

According to some embodiments, the graphical user interface 510 may further include a signoff section. The signoff section may involve completion of one or more signoff fields. A signoff field may be configured as an answer to a yes-or-no question, such as “did a control owner delegate you or someone in the group to conduct/participate as a control performance reviewer during this observation?” Additionally or alternatively, a signoff field may be configured as a selection option from a set of options to answer a question such as “was this an individual observation or a group observation?” A skilled artisan will understand that the phrasing of the questions may be modified to seek additional or similar signoff information, while keeping with the purpose of seeking signoff information about the control. Selection of one or more answer options may lead to the creation of additional signoff fields. For example, a selection of “yes” in response to the question “did a control owner delegate you or someone in the group to conduct/participate as a control performance reviewer during this observation?” may lead to the display of a further field, such as an answer to the question “who are you delegating for?” The answer to this further signoff field may involve selection of an option from a list of options in a dropdown menu. As another example, selection of “group observation” in response to the question “was this an individual observation or a group observation?” may lead to the display of a further field, such as an answer to the question “how many additional members are in your group?” This question may be answered through a numerical answer, which may prompt the display of group member name fields.

The signoff section may further involve selection of one or more completion options, which may involve selection of a button having identifying text. The identifying text may identify the button as a submit button, a save as draft button, or a view another button. Submission following selection of the submit button may include confirmation of completion of each field or a subset of fields that may be marked as required fields.

The graphical user interface 510 may involve one or more edit existing observation operations, which may permit the revision of an existing observation. Editing an existing observation may involve display of populated fields associated with observation creation and the ability to modify the responses in those fields.

The graphical user interface 510 may involve one or more view completed observations operations, which may permit viewing, but not revising, completed observations. Viewing a completed observation may involve display of populated fields associated with observation creation as read-only fields.

Some embodiments include additional control detail fields, which may include control effectiveness, control frequency, control description, and control owners. The additional control detail fields may be configured to auto-populate in response to population of the selection fields. Some embodiments further include free-form fields, which may be specific to the selected risk control. In some embodiments, the free-form fields may be left blank if inapplicable. In other embodiments, an entry such as “N/A” must be included to respond to each free-form field. The free-form fields may request information about the purpose of the selected control, the risk or risks it is meant to address, the actions the control takes to address the risk or risks, and evidence that the control was performed.

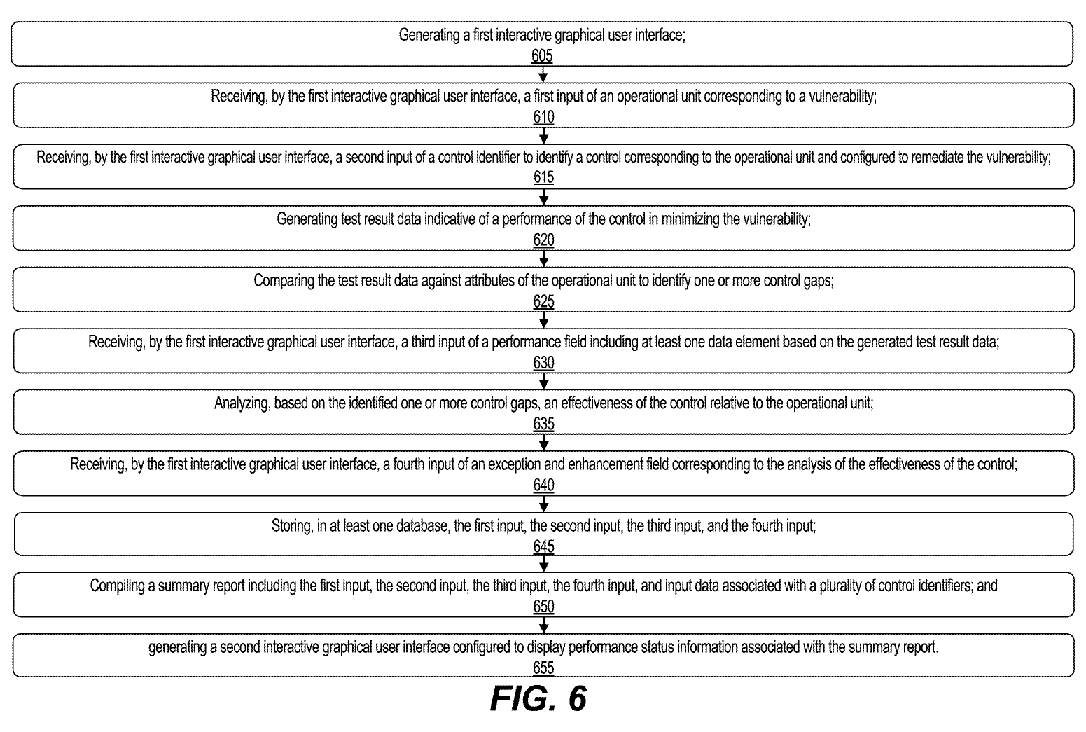

FIG. 6 illustrates a flowchart illustrating an example process for receiving inputs related to a control through a graphical user interface, consistent with disclosed embodiments. At step 605, the process may include generating a first interactive graphical user interface. This interface may serve as the primary tool for interacting with agents of an organization such as risk managers, compliance personnel, or IT staff. For example, the interface may present fields for entering details about observed vulnerabilities and documenting control effectiveness. It may also include options for uploading documents to ensure all necessary information may be captured and processed.

At step 610, the process may further include receiving, by the first interactive graphical user interface, a first input of an operational unit corresponding to a vulnerability. For example, finance analyst may select the “finance department” as the operation unit and indicate that the vulnerability to be remediated is “outdated software that is missing security patches.”

According to some embodiments, the process may determine the operational unit by correlating a vulnerability with integrated data, such as which department an asset is assigned to. For example, when a vulnerability such as “outdated software missing security patches” is detected, the system identifies affected workstations and maps them to the appropriate department.

At step 615, the process may further include receiving, by the first interactive graphical user interface, a second input of a control identifier to identify a control corresponding to the operational unit and configured to remediate the vulnerability. For example, a finance analyst may enter “automated patch management system” as the control identifier. This input may ensure that the underlying system accurately associates the control with the relevant operational unit and vulnerability.

At step 620, the process may further include generating test result data indicative of a performance of the control in minimizing the vulnerability. For example, after implementing a control such as an “automated patch management system” to address outdated software, the process may run periodic tests to measure the percentage of devices successfully updated and the reduction in security incidents related to unpatched devices.

According to some embodiments, the process may generate test result data through data pipelines that continuously monitor implemented controls. For example, after deploying an automated patch management system to remediate outdated software vulnerabilities, the system may be integrated with endpoint management and security monitoring platforms. These integrations may allow the process to collect test result data, such as the percentage of devices successfully updated and the frequency of security incidents related to unpatched software.

At step 625, the process may further include comparing the test result data against attributes of the operational unit to identify one or more control gaps. For example, even after implementing a control such as an “automated patch management system” to address outdated software, the system may compare the number of workstations updated with the patch against the total number of workstations that are not updated and identify that 10% of the total workstations remain unpatched, the process may identify this as a control gap.

At step 630, the process may further include receiving, by the first interactive graphical user interface, a third input of a performance field including at least one data element based on the generated test result data. For example, after implementing a control such as an “automated patch management system” to address outdated software, the finance analyst may enter or upload data such as “90% of workstations patched this month.”

In further embodiments, the third input of the performance field indicates whether the control is manual or inefficient, and the fourth input of the exception and enhancement field includes data with instructions on enhancing the control by introducing technology-driven processes when such involvement is present.. For example, a contract analyst working for an organization may indicate that reviewing contracts for risk exposure is done by employees via visual inspection. When a control is identified as inefficient (e.g., visual inspection), the fourth input may be used to enter instructions for enhancing the control for improved efficiency which may include using artificial intelligence to conduct an initial review or other software.

In further embodiments, the third input of the performance field comprises data including at least one of non-numerical data and numerical data. For example, an observer may record numerical data such as the number of incidents detected by an automated security system or the average response time to a security alert. The observer may also input non-numerical data such as descriptive feedback on the user-friendliness of the automated control or other notes.

At step 635, the process may further include analyzing, based on the identified one or more control gaps, an effectiveness of the control relative to the operational unit. For example, after implementing a control such as an “automated patch management system” to address outdated software, the process may then evaluate the effectiveness of the control. For example, determining how effective the patch management system is at remediating the vulnerability of security incidents. As a result, the system may completely eradicate the vulnerability by resulting in zero security incidents, or partially remediate the vulnerability by reducing the number of security incidents. Completely eradicating the incident may result in 100% efficiency.

According to some embodiments, the process may evaluate performance by analyzing test result data generated during control implementation. The system may extract relevant metrics, such as operational benchmarks, directly from integrated data sources. For example, after deploying an automated patch management system, the system may calculate a metric like “90% of workstations patched this month” based on collected patching logs. These calculated values are then compared against predefined thresholds such as a minimum compliance threshold of 85%.

In further embodiments, the analyzing is performed by an artificial intelligence model, the artificial intelligence model being configured to generate one or more enhancement actions for one or more controls.

At step 640, the process may further include receiving, by the first interactive graphical user interface, a fourth input of an exception and enhancement field corresponding to the analysis of the effectiveness of the control. For example, after implementing a control such as an “automated patch management system” to address outdated software, the finance analyst may note an exception such as “legacy accounting software is not compatible with patch software.” Additionally, as an enhancement, the finance analyst may suggest an enhancement such as “using new patch management software applicable to all platforms.”

At step 645, the process may further include storing, in at least one database, the first input, the second input, the third input, and the fourth input. The database may include structure such as the database described in connection to FIGS. 3, 4, and 7.

At step 650, the process may further include compiling a summary report including the first input, the second input, the third input, the fourth input, and input data associated with a plurality of control identifiers. For example, this report may include a table listing each department, the vulnerabilities identified, the controls implemented, and their effectiveness evaluations, and any enhancements suggested to enable stakeholders to quickly assess the status of risk mitigation efforts.

At step 655, the process may further include generating a second interactive graphical user interface configured to display performance status information associated with the summary report. For example, the interface may include a graph view showing a bar chart comparing control effectiveness scores by operational unit (e.g., operations, human resources, finance, engineering, legal). Users may view tables that list metrics such as number of recorded exceptions, qualitative ratings from observers, and the status of recommended enhancements (e.g., planned, in progress, completed). Filter may allow stakeholders to organize the data by vulnerability type (e.g., outdated software), department, date range, or automation level.

In further embodiments, the process may further include identifying, among a plurality of control identifiers, two or more controls that remediate the same vulnerability and removing one of the two or more controls from implementation. For example, two controls may address the same vulnerability such as unauthorized access to confidential data. The first control may include manual weekly audits by a security team. The second control is an automated monitoring tool that continuously monitors access data and immediately alerts security teams to unauthorized access attempts. After evaluating the effectiveness of both controls, it may remove apparent that the manual audit is inefficient and much less reliable than the automated tool. The process will recognize the redundancy and remove the manual audit from implementation thereby retaining a more efficient control framework.

In further embodiments, the second interactive graphical user interface includes at least one graphical representation of the effectiveness of the control, wherein the graphical representation is selected from a graph or a table. For example, the interface may display a graph summarizing metrics such as the number of vulnerabilities address, the frequency of control exceptions, and change in the number of automated controls.

In further embodiments, the process may further include prioritizing enhancements by analyzing identified control gaps and the vulnerability to be remediated associated with each of the control identifiers. For example, after reviewing the control framework of organization 120, the control framework may show that the organization is susceptible to several critical vulnerabilities that are either insufficiently addressed or not addressed at all. By mapping each control to its associated vulnerability, the organization may determine which gaps pose the greatest risk and require immediate action. For example, controls that fail to fully remediate highly critical vulnerabilities are flagged for enhancement such as upgrading manual security patching to automated solutions.

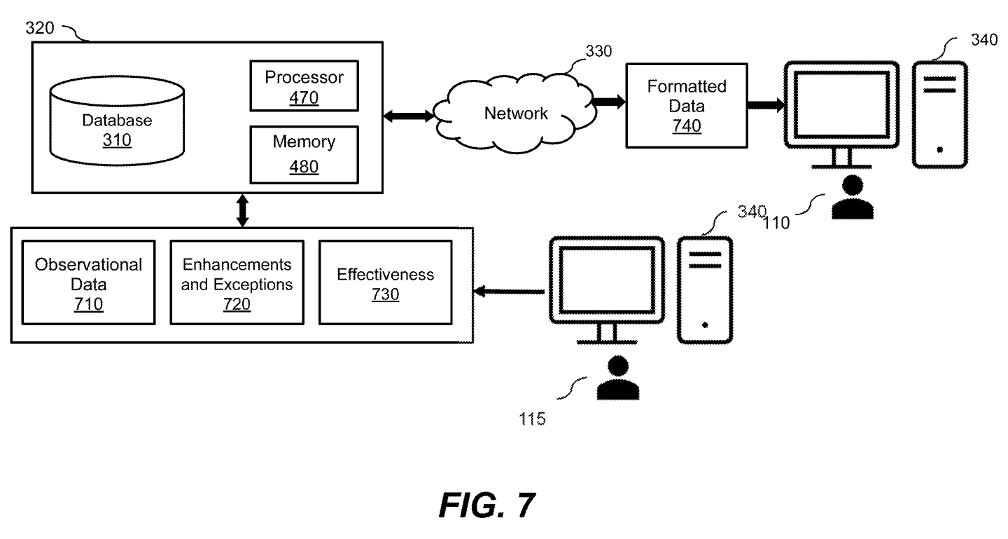

FIG. 7 is a diagram of an exemplary system architecture for receiving inputs related to a control through a graphical user interface or integrated data pipelines, consistent with disclosed embodiments. The process may begin with entity 115, which may be an analyst, organization, financial institution, or integrated data pipeline (e.g., asset management software) entering control observation data 710, enhancements and exceptions 720, and effectiveness assessments 730 through an endpoint device 340 via a graphical user interface. For example, the graphical user interface may receive observational data related to control that mitigates a vulnerability related to outdated software that is missing critical security patches. An entity 115, such as an integrated data pipeline, may be prompted by the monitoring tool to provide observational data by providing asset management data regarding workstations in an organization 120 that are running operating systems that do not have the patch. In the enhancements input section, the integrated systems 115 may provide data that indicates the necessity for uploading an automated patch management tool to ensure all workstations receive critical updates as they roll out. For effectiveness, the data from the asset management software may indicate that the current controls are only partially effective due to the workstations found without the critical security patches exposing organization 120 to vulnerabilities such as malware or data breaches.

The system operates over a network 330 using a computing device 320, which contains a processor 470, memory 480, and a database 310. The computing device organizes the inputs by generating formatted data 740 that is accessible to entity 110 on an endpoint device 340. According to some embodiments the formatted data 740 includes dashboards or reports that highlight trends such as the number of reported observations by an entity 120, the number of exceptions reported, or enhancements reported.

Throughout this process, the system components may communicate over network 330 which may include local area networks (LAN), wide area networks (WAN), or cloud-based infrastructure. This networked environment may enable distributed processing and access to remote databases or documentation services, supporting scalability and integration across enterprise systems.

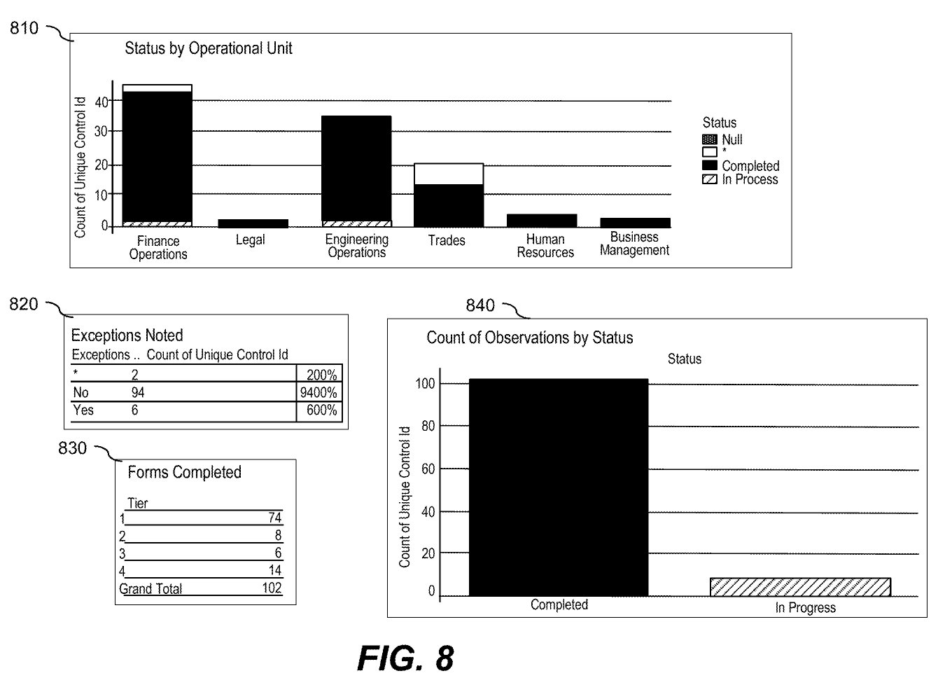

FIG. 8 illustrates reports and graphs output from the control observation tool, consistent with disclosed embodiments. Table 810 illustrates a bar chart that displays the count of controls within each operational unit such as finance operations, engineering, and legal. Each bar in the bar chart is segmented by a status of the control such as “Null” (e.g., no status assigned), “completed” (e.g., assessment finished), or “in process” (e.g., assessment is ongoing). Table 810 may enable stakeholders to quickly compare how many controls are being evaluated via the monitoring tool per operational unit. Table 820 summarizes the number of exceptions reported via the graphical user interface of the monitoring tool. Table 820 may enable stakeholder to quickly evaluate the amount of improvement possible for existing controls throughout the organization.

Table 830 provides a summary of the total number of completed control assessments, organized by tier. When reporting control observations, users assess both the criticality of each control and the vulnerability it addresses. For instance, a tier 4 (highly critical) control is one that mitigates a vulnerability with a high likelihood of occurrence and significant impact on the organization such as power loss to a factory due to inclement weather, which could result in asset damage and machine downtime. Conversely, a tier 1 (low criticality) control addresses scenarios that are highly unlikely, such as a meteor strike on the organization’s facility. Controls designed to mitigate such rare events would typically be classified as tier 1. By categorizing assessments in this way, Table 830 enables the organization to track both the distribution and completion rate of control assessments across all criticality tiers, supporting more effective risk management and resource allocation. Table 840 is a bar chart showing the overall count of control observations by their status. Table 840 may enable stakeholders to quickly assess the overall completion rate and identify any remaining reporting requirements.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present disclosure .

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device .

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosure, which are, for clarity, described in the context of separate embodiments, may also be provided in combination in a single embodiment. Conversely, various features, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A computer-implemented method comprising the following operations performed by one or more processors:
generating a first interactive graphical user interface;
receiving, by the first interactive graphical user interface, a first input of an operational unit corresponding to a vulnerability;
receiving, by the first interactive graphical user interface, a second input of a control identifier to identify a control corresponding to the operational unit and configured to remediate the vulnerability;
generating test result data indicative of a performance of the control in minimizing the vulnerability;
comparing the test result data against attributes of the operational unit to identify one or more control gaps;
receiving, by the first interactive graphical user interface, a third input of a performance field including at least one data element based on the generated test result data;
analyzing, based on the identified one or more control gaps, an effectiveness of the control relative to the operational unit;
receiving, by the first interactive graphical user interface, a fourth input of an exception and enhancement field corresponding to the analysis of the effectiveness of the control;
storing, in at least one database, the first input, the second input, the third input, and the fourth input;
compiling a summary report including the first input, the second input, the third input, the fourth input, and input data associated with a plurality of control identifiers; and
generating a second interactive graphical user interface configured to display performance status information associated with the summary report.

2. The method of claim 1, further comprising:
identifying, among the plurality of control identifiers, two or more controls that remediate the same vulnerability; and
removing one of the two or more controls from implementation.

3. The method of claim 1, wherein the second interactive graphical user interface includes at least one graphical representation of the effectiveness of the control, wherein the graphical representation is selected from a graph or a table.

4. The method of claim 1, wherein the third input of the performance field indicates whether the control is manual and the fourth input of the exception and enhancement field includes data with instructions on enhancing the control with automation when the control is manual.

5. The method of claim 1, wherein the third input of the performance field comprises data including at least one of non-numerical data or numerical data.

6. The method of claim 1, further comprising prioritizing enhancements by analyzing identified control gaps and the vulnerability associated with the control identifier.

7. The method of claim 1, wherein the analyzing is performed by an artificial intelligence model, the artificial intelligence model configured to generate one or more enhancement actions for the control.

8. A system comprising:
a memory device including program instructions; and
at least one processor configured to execute the program instructions to:
generate a first interactive graphical user interface;
receive, by the first interactive graphical user interface, a first input of an operational unit corresponding to a vulnerability;
receive, by the first interactive graphical user interface, a second input of a control identifier to identify a control corresponding to the operational unit and configured to remediate the vulnerability;
generate test result data indicative of a performance of the control in minimizing the vulnerability;
comparing the test result data against attributes of the operational unit to identify one or more control gaps;
receive, by the first interactive graphical user interface, a third input of a performance field including at least one data element based on the generated test result data;
analyze, based on the identified one or more control gaps, an effectiveness of the control relative to the operational unit;
receive, by the first interactive graphical user interface, a fourth input of an exception and enhancement field corresponding to the analysis of the effectiveness of the control;
store, in at least one database, the first input, the second input, the third input, and the fourth input;
compile a summary report including the first input, the second input, the third input, the fourth input, and input data associated with a plurality of control identifiers; and
generate a second interactive graphical user interface configured to display performance status information associated with the summary report.

9. The system of claim 8, further comprising the program instructions to:
identify, among the plurality of control identifiers, two or more controls that remediate the same vulnerability; and
remove one of the two or more controls from implementation.

10. The system of claim 8, wherein the second interactive graphical user interface includes at least one graphical representation of the effectiveness of the control, wherein the graphical representation is selected from a graph or a table.

11. The system of claim 8, wherein the third input of the performance field indicates whether the control is manual and the fourth input of the exception and enhancement field includes data with instructions on enhancing the control with automation when the control is manual.

12. The system of claim 8, wherein the third input of the performance field comprises data including at least one of non-numerical data or numerical data.

13. The system of claim 8, further comprising the program instruction to prioritize enhancements by analyzing identified control gaps and the vulnerability associated with the control identifier.

14. The system of claim 8, wherein the analyzing is performed by an artificial intelligence model, the artificial intelligence model configured to generate one or more enhancement actions for the control.

15. A non-transitory computer-readable medium storing instructions that, when executed by one or more processors, cause the one or more processors to:
generate a first interactive graphical user interface;
receive, by the first interactive graphical user interface, a first input of an operational unit corresponding to a vulnerability;
receive, by the first interactive graphical user interface, a second input of a control identifier to identify a control corresponding to the operational unit and configured to remediate the vulnerability;
generate test result data indicative of a performance of the control in minimizing the vulnerability;
comparing the test result data against attributes of the operational unit to identify one or more control gaps;
receive, by the first interactive graphical user interface, a third input of a performance field including at least one data element based on the generated test result data;
analyze, based on the identified one or more control gaps, an effectiveness of the control relative to the operational unit;
receive, by the first interactive graphical user interface, a fourth input of an exception and enhancement field corresponding to the analysis of the effectiveness of the control;
store, in at least one database, the first input, the second input, the third input, and the fourth input;
compile a summary report including the first input, the second input, the third input, the fourth input, and input data associated with a plurality of control identifiers; and
generate a second interactive graphical user interface configured to display performance status information associated with the summary report.

16. The system of claim 15, further comprising the program instructions to:
identify, among the plurality of control identifiers, two or more controls that remediate the same vulnerability; and
remove one of the two or more controls from implementation.

17. The non-transitory computer-readable medium of claim 15, wherein the second interactive graphical user interface includes at least one graphical representation of the effectiveness of the control, wherein the graphical representation is selected from a graph or a table.

18. The non-transitory computer-readable medium of claim 15, wherein the third input of the performance field indicates whether the control is manual and the fourth input of the exception and enhancement field includes data with instructions on enhancing the control with automation when the control is manual.

19. The non-transitory computer-readable medium of claim 15, wherein the third input of the performance field comprises data including at least one of non-numerical data or numerical data.

20. The non-transitory computer-readable medium of claim 15, further comprising the program instruction to prioritize enhancements by analyzing identified control gaps and the vulnerability associated with the control identifier.
